(19) United States
(12) Patent Application Publication
(10) Pub. No.: US 2011/0220848 A1
(43) Pub. Date: Sep. 15, 2011

(54) GASIFICATION OF CRUDE GLYCEROL

(75) Inventors: Hubertus WINKLER, Grainau (DE); Frank Wiessner, Pullach (DE); Axel Behrens, Munchen (DE); Wibke Korn, Munchen (DE)

(73) Assignee: LINDE AKTIENGESELLSCHAFT, Munchen (DE)

(21) Appl. No.: 13/042,765

(22) Filed: Mar. 8, 2011

(30) Foreign Application Priority Data
Mar. 9, 2010 (DE) 10 2010 010 738.7

(51) Int. Cl. C01B 3/02; C07C 29/76; B01J 10/02

(52) U.S. Cl. 252/373; 568/913; 422/187

(57) ABSTRACT

The invention relates to a method (20) for processing (1, 2) a glycerol-containing feedstock mixture (G) to produce an intermediate (I), suitable for use as a feed to a pyrolysis process. Additionally, the invention relates to a method (10) for generating a hydrogen-containing product mixture (H) from the intermediate (I) by means of pyrolysis (3), and subjecting the pyrolysis product (P) to reaction (4). In accordance with the invention, the processing (1, 2) proceeds under at least partial vaporization (1) of the feedstock mixture (G) by thin-film evaporation, obtaining a vaporization product (V).

### SUMMARY OF THE INVENTION

The present invention relates to a method for processing a glycerol-containing feedstock mixture to form an intermediate, a method for generating a hydrogen-containing product mixture from the intermediate, and also to a corresponding device.

In attempts to decrease the input of carbon dioxide into the earth's atmosphere or at least not to allow it to increase further, and as alternatives to the disappearing reserves of petroleum and natural gas, in the future energy sources from renewable raw materials will increasingly be used. According to an EU guideline, in the European Union, by the year 2010, at least 5.75% of the fuel requirement should be covered by such energy sources. Biodiesel plays an outstanding role in this case which is already now being added at a concentration of up to five percent to the diesel fuel available at German filling stations.

Biodiesel is a standardized fuel which is obtained in Europe principally from rapeseed oil, but also from other vegetable oils and fats such as soya oil. Such oils and fats are triglycerides, that is to say glycerol triesters of various fatty acids. Vegetable oils and fats, at standard ambient temperatures, are viscous to solid, that is to say have a much higher viscosity than the fuels for which a conventional diesel engine on the market is designed. Vegetable oils and fats differ, in addition, from conventional fuels in their injection behavior and their combustion properties (flash point, cetane number, residues). These disadvantages may be compensated for only incompletely even by interventions with respect to the engine such as, for example, preheating the vegetable oil. In addition, such interventions with respect to the engine generally require expensive conversion of corresponding vehicles.

Biodiesel is produced by transesterifying the fatty acids of triglycerides with alcohol, for example methanol. The viscosity, the injection behavior and the combustion properties of biodiesel substantially correspond to conventional diesel fuel, for which reason biodiesel is useable, at least up to a certain fraction, without problems even in unmodified diesel engines.

The glycerol resulting from the transesterification does not occur in a pure form, but forms a part of a mixture of matter. Such a crude glycerol has a glycerol content of 80-85%, but additionally still contains relatively large amounts of water and salts, residues from the production process (solvent and catalyst residues) and also organic components (Material Organic Non-Glycerol (MONG)). According to the prior art, crude glycerol is purified, for example, in complex process steps by vacuum distillation, deodorization and filtration, to the extent that it satisfies the requirements of the European Pharmacopoeia and can be sold to the pharmaceutical industry as what is termed pharmaceutical glycerol at a purity of at least 99.5%.

Currently, all of the glycerol occurring in biodiesel production can be utilized in this way. However, with the foreseeable expansion of biodiesel production, in the future overcapacities of glycerol may be expected, and so other economically expedient utilization pathways are required therefore.

In addition to biodiesel, hydrogen is also known to be an increasingly used renewable energy source which is customarily obtained by the electrolysis of water. Because of the increasing use of hydrogen in vehicle engines and systems for energy recovery, in particular in connection with fuel cell technology, and with new methods for hydrogen storage, an increased requirement for hydrogen may be expected in the future. Since the production of hydrogen from glycerol is known in principle, the production of hydrogen is an attractive utilization route for crude glycerol which appears to be suitable to cover at least in part the increased requirement for hydrogen.

For producing hydrogen from oxygenated hydrocarbons such as glycerol, but also from biomass, steam reforming, for example, after, or with simultaneous, pyrolytic conversion is customary. For this purpose, frequently nickel catalysts are used on suitable support materials. The feed materials in this case are generally preheated and conducted together with steam over the catalyst. For this purpose high-temperature methods proceeding at 400-900° C. or more are known, but low-temperature methods as are disclosed, for example, in U.S. Pat. No. 6,964,757 B2, U.S. Pat. No. 6,964,758 B2 and U.S. Pat. No. 6,699,457 B2 are also known.

Then, for establishing the desired hydrogen/carbon monoxide ratio and/or for purifying the hydrogen, for example the water gas shift reaction, a membrane method and/or pressure-swing adsorption may be used.

Direct further processing of crude glycerol by pyrolysis and steam reforming (hereinafter also called pyroreforming) is impeded by its abovementioned impurities and also by quality differences caused by differing sources and production methods. In particular, salts, in aqueous media, can lead to corrosion of plant components and deactivate the catalysts used. Also, organic impurities are able to be controlled only with difficulty and can lead to deposits and the formation of soot. Known methods therefore generally use appropriately purified (pharmaceutical) glycerol, the production of which, however, is associated with high costs owing to the expenditure in terms of apparatus.

DE 10 2007 007 022 962 A1, DE 10 2007 022 962 A1 (US 2008/0283798) and DE 10 2007 060 166 A1 (US 2009/0151254) of the applicant address these problems and propose separating off unwanted substances from the crude glycerol before the pyrolysis, for example by thermal drying or vacuum distillation. In contrast, for example, the applicant's DE 10 2007 045 360 A1 (US 2009/0077888) contains a method in which a pyrolysis method is conducted in such a manner that residues formed from using crude glycerol can be taken off continuously.

However, the prior art methods are frequently disadvantageous, in particular from the aspects of energy and/or apparatus.

It is therefore an object of the present invention to specify a method of the type in question to feed by-products occurring in biodiesel production and which contain glycerol to an economic utilization, and by which method the disadvantages of the prior art are overcome.

Upon further study of the specification and appended claims, other objects and advantages of the invention will become apparent.

These objects are achieved by a method for processing a glycerol-containing feedstock mixture to form an intermediate, a method for generating a hydrogen-containing product mixture from the intermediate, and also a corresponding device having the features of the independent claims. Preferred embodiments are subject matter of the subclaims and also of the description hereinafter.

According to the invention, a glycerol-containing feedstock mixture, for example crude glycerol from biodiesel production, is processed at least in part by thin-film evaporation, whereby a corresponding vaporization product is obtained.

It has been found that thin-film evaporation makes it possible particularly simply and inexpensively to separate off salts that can be harmful to subsequent process steps. Other components, in particular water and certain MONG components which do not necessarily impair the subsequent process steps can, in contrast, in part pass into the vaporization product (vapors) and can thereby be transferred, for example, into a subsequent pyrolysis appliance. The components passing over into the gas phase in accordance with their boiling point may be set in a targeted manner by the choice of suitable temperature and pressure conditions and are distributed accordingly between vapors and bottom product.

Organic components that are distilled off are then pyrolyzed together with the glycerol and can thus likewise be used for hydrogen production. In the conventional purification for producing pharmaceutical glycerol, corresponding components, in contrast, are separated off and must be disposed of, possibly at a not insignificant expenditure.

In the context of the present application, the residue of evaporation containing the salts and non-vaporized MONG fractions can be discharged as a high-viscosity volume-reduced liquid from the bottom of the evaporator. The water passing over can be used in the subsequent steam reforming process without any significant additional energy input. In this case, advantageously, the evaporation conditions can be controlled in a targeted manner such that the desired water fraction is already set in the processing step. The steam that passes over can also act as energy input for a subsequent pyrolysis method.

In other words, the method according to the invention makes possible a purification of the crude glycerol by means of which only the components that are unwanted for a downstream thermal method are removed in a targeted manner reliably, inexpensively and simply.

Thin-film evaporation is known per se. The vaporization proceeds from a thin liquid film in a thin-film evaporator. The mixture of matter that is to be separated for this purpose is distributed via a rotating distributor system from the top on the periphery of a cylindrical evaporator and flows downwardly on the internal surface thereof. A wiper system ensures uniform distribution on the internal surface and permanent mixing of the material flowing downwards.

The evaporator is generally constructed with a double wall. For uniform heating of the evaporator surface, a heat carrier medium (e.g. thermal oil or steam) is conducted through the jacket. The more volatile substances vaporize from the liquid film flowing downwards, depending on the temperature of the liquid and the operating pressure in the evaporator. The vapors are passed upwards in countercurrent flow to the liquid film.

The operating pressure in thin-film evaporators is generally an absolute pressure of 1 mbar to 1 bar, that is to say in the vacuum range up to atmospheric pressure. Thin-film evaporation makes possible firstly a marked reduction of the evaporator temperatures in comparison with other evaporation methods. The residence time at vaporization temperature of the mixture of matter that is fed is on the other hand very short and is frequently markedly less than one minute. Owing to the low residence time, higher vaporization temperatures can be used without thermal decomposition processes being feared.

It has been found that in the thin-film evaporation of crude glycerol, in contrast to the customarily used temperatures of approximately 160° C., with particular advantage a temperature of 170 to 240° C. can be used, advantageously a temperature of above 200° C., in particular from 200 to 240° C., preferably from 200 to 220° C., without the glycerol displaying decomposition processes. The higher vaporization temperatures are also accompanied by a higher vaporization pressure which may be achieved simply and inexpensively by simplified vacuum appliances.

An absolute pressure of 50 to 85 mbar has proved to be particularly advantageous in this context.

As a particular advantage of the thin-film evaporation, it has been found that by the targeted use of the stated relatively high vaporization temperatures or pressures, what is termed water flash (that is to say abrupt evaporation of water on pressure fall and formation of aerosols and water droplets) can be avoided. The principal cause of the formation of salt-containing aerosols that can pass over into the distillate is hereby reliably eliminated.

As already explained, the method introduced is suitable, in particular, for treating glycerol-containing substances such as crude or substandard glycerol as occurs in biodiesel production.

For a further purification, in particular for removal of salts, the vaporization product, that is to say the vapors generated by the thin-film evaporation, can be purified by at least one scrubbing appliance, for example a vapor scrubber. Even with high salt loadings, a relatively reliable process procedure can be achieved thereby without the risk of catalyst damage or corrosion, since the salt transfer is minimized by entrainment. By using a scrubbing appliance, in a particularly cost- and energy-saving manner, an otherwise possibly required second distillation stage can be dispensed with.

In order to separate off part of the unwanted substances present in the feedstock mixture even before the processing according to the invention, said feedstock mixture can also be subjected to an additional purification method, for example a distillation, a thermal drying, a filtering through activated charcoal and/or a membrane and/or a chromatographic, ion-exchanger and/or ion-exclusion method.

Particularly advantageous and inexpensive methods have proved in this context to be predrying and saponification. Predrying, which is known per se, can be used in particular at high water contents. Although it requires the use of an additional device and additional energy input, on the other hand, the required energy input into the thin-film evaporation system can however be decreased thereby owing to the lower total volume to be warmed and also to a prewarming which has already proceeded.

Also in this case, advantageously, a controlling influence of the water content on later water-requiring reaction steps can proceed. Depending on the crude glycerol quality used, the MONG content can vary greatly and influence the quality of the distillation product, for example by organic chlorides. A targeted setting of the pH can effect, for example, a saponification of alkanoic acids which remain in the bottom product owing to the higher boiling point.

The method that is likewise provided according to the invention for generating a hydrogen-containing product mixture from the intermediate as obtained by the processing method, comprises the pyrolysis of the intermediate, obtaining a pyrolysis product, and also reaction thereof to form a water-containing product mixture. The pyrolysis product is present in the pure gaseous state. In this manner, technically and economically complex purification steps before entry into the reaction step are avoided.

Of course, the hydrogen-containing product mixture can be subjected to further processing steps, for example a water gas shift reaction, in which preferably large parts of the carbon monoxide present in the product mixture are reacted with water to form hydrogen and carbon dioxide (equilibrium reaction). The product mixture is effectively detoxified thereby. Alternatively, or in addition, for example a pressure-swing adsorption method can also be used to obtain high-purity hydrogen.

Particularly advantageously, for reacting the intermediate, steam reforming and/or a partial oxidation can be used such as are disclosed and extensively explained, for example, in the applicant's applications DE 10 2007 007 022 962 A1, DE 10 2007 022 962 A1 (US 2008/0283798) and 10 2006 020 985 A1.

The steam reformer that can be used is preferably a tubular reactor such as is also used, for example, for the steam reforming of methane. The steam reformer can comprise at least one catalyst material which is selected from nickel, platinum, palladium, iron, rhodium, ruthenium and/or iridium. Advantageously, the catalyst material is a material which is also suitable for the catalytically supported steam reforming of naphtha or methane. By using known tubular reactors and catalysts, plant components having low additional costs can also be used for the hydrogen production from crude glycerol.

Preferably, the pyrolysis can be carried out in the convection zone of a corresponding steam reformer, which convection zone is constructed for this purpose as a pyrolysis reactor. The pyrolysis can also be carried out with feed of water, steam and/or an oxidizing agent, wherein the oxidizing agent can be, for example, air, oxygen-enriched air or oxygen. However, the pyrolysis can be carried out with particular advantage in the absence of air. It has been found that a particularly advantageous pyrolysis of a correspondingly processed intermediate proceeds at a temperature of 500 to 750° C. and an absolute pressure of 20 to 40 bar with purely gaseous pyrolysis products being obtained. The pyrolysis product in this case substantially contains carbon monoxide, methane, hydrogen and carbon dioxide. The pyrolysis conditions can be optimized by adapting temperature, pressure and water content and also the type of heat input and thus the residence times, in such a manner that the formation of solid and liquid products is very largely avoided.

The required energy input for the pyrolysis and steam reforming proceeds, in contrast to known methods, non-electrically. The process steps are carried out in a steady state in a suitable device. The required energy input proceeds via radiant heat and/or convection heat. If, for example, the hydrogen is separated off from a product mixture via pressure-swing adsorption, the residual gas that is obtained as a product in addition to high-purity high-pressure hydrogen can, by combustion, cover some of the energy required and thereby increase the overall efficiency.

A reactor that can be used for partial oxidation advantageously has a burner through which a pyrolysis product and an oxidizing agent, preferably air, oxygen-enriched air, or oxygen, and/or steam, can be fed separately or as a mixture of matter. A corresponding burner for this purpose has concentrically arranged ring gaps and is equipped with at least one spin body via which a mixture of matter that is fed through the burner can be given a tangential spin. The burner has cooling channels and is made at least in parts of a material resistant to high temperature.

Expediently, the water or steam content of the intermediate processed from the feedstock mixture is set by addition or removal of water or steam to a value which makes it possible to carry out a subsequent pyrolysis without soot formation and with simultaneously minimum energy input. As mentioned, the water or steam content can already be preset by setting the water content of the feedstock mixture by predrying or by selection of the evaporation conditions. Another embodiment of the method according to the invention envisages feeding the water required for the pyrolysis in more than one step, before and/or during the pyrolysis stepwise at a suitable point. If the pyrolysis is carried out in a plurality of sequentially following steps, the water feed expediently proceeds in each case before a pyrolysis step.

If the intermediate is fed to the pyrolysis in liquid form, water is introduced, preferably in the form of steam, wherein the steam is injected into the intermediate or the intermediate into the steam. With the steam, a considerable part of the energy required for the subsequent pyrolysis is already introduced, which leads to a reduced expenditure of heat in the pyrolysis reactor and to a reduction of the apparatus complexity for the pyrolysis reactor.

The energy consumption of the method according to the invention is influenced, inter alia, by the amount of water that is to be heated in the steam reformer. The greater this amount of water, the greater is the energy requirement. In order to optimize the energy requirement of the method according to the invention, the input fed to the steam reformer therefore expediently has only a minimum water content, the size of which is determined by the subsequent process steps. The minimum water content results from the demand that soot formation in the steam reformer is completely suppressed and at the same time sufficient water remains in the product mixture in order to be able to carry out water-consuming process steps that follow the steam reforming (e.g. a water gas shift reaction) without further feed of water. Expediently, therefore, the water or steam content of the intermediate is set to the minimum water content by addition or removal of water or steam before the steam reforming.

A device suitable for carrying out the method according to the invention comprises, in particular, a thin-film evaporator by means of which a glycerol-containing feedstock mixture can be processed, a pyrolysis appliance in which the intermediate obtained by the processing can be pyrolyzed, and a reaction appliance in which the hydrogen-containing product mixture can be produced from a pyrolysis product generated in the pyrolysis appliance.

Advantageously, one pyrolysis reactor and one catalysis reactor (for example a steam reformer) form a structural unit. The required energy input for the pyrolysis reaction and also for the steam reforming proceeds via radiant and/or convection heat. For instance, the pyrolysis reactor can be operated by convection heat or else by radiant heat. Preference is given to an installation of pyrolysis reactor and steam reformer in a radiant zone. By means of this processing conversion, in particular the energy losses, for example via a piping system, can be kept minimal.

With reference to further advantages of the device according to the invention, reference is made exclusively to the process features described hereinbefore.

Further advantages and embodiments of the invention result from the description and the accompanying drawing.

It is understood that the abovementioned features and the features still to be described hereinafter can be used not only in the combination cited in each case, but also in other combinations or alone, without leaving the context of the present invention.

### BRIEF DESCRIPTION OF THE DRAWINGS

The invention is illustrated schematically with reference to an exemplary embodiment in the drawing and will be described extensively hereinafter with reference to the drawing. Various other features and attendant advantages of the present invention will be more fully appreciated as the same becomes better understood when considered in conjunction with the accompanying drawing wherein:

FIG. 1 shows a schematic representation of a method proceeding according to a particularly preferred embodiment of the invention.

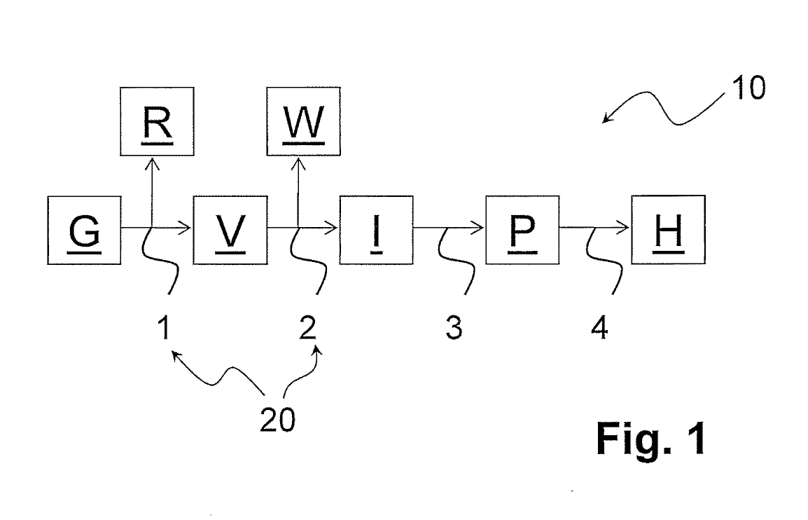

In the single FIG. 1, a method proceeding according to a particularly preferred embodiment of the invention is shown and designated overall by 10.

In the method, a glycerol-containing feedstock mixture G, for example crude glycerol from biodiesel production, is used. It is understood that the feedstock mixture G can be processed in a corresponding manner, for example prepurified, dried, saponified and/or filtered.

From the feedstock mixture G, a vaporization product V is obtained by thin-film evaporation 1. In addition, in the thin-film evaporation 1, a residue R is obtained in the form of the bottom product that is continuously or intermittently taken off from the thin-film evaporator. The residue R can be further treated for better landfilling and/or utilization, for example can be granulated or scrubbed.

The vaporization product, for example in the form of vapors, is scrubbed in a scrubbing step 2, for example in a vapor scrubber, and is optionally further processed. As a result, an intermediate I is obtained. In the context of the further processing 2, for example an aqueous salt solution is obtained as a loaded scrubbing residue W, which can likewise be further treated in a suitable manner.

The thin-film evaporation 1 and the subsequent scrubbing 2 can be summarized as a preferred processing step 20 according to the invention.

The intermediate I is then reacted by pyrolysis 3 to give a purely gaseous pyrolysis product P.

The pyrolysis product P is reacted in process step 4, for example in a steam reformer with catalytic support, to produce the hydrogen-containing product mixture H, a product mixture containing predominantly hydrogen and carbon monoxide.

The method can comprise further process steps that are not shown here for further treatment of the product mixture P such as, for example, a water gas shift reaction and/or a gas swing adsorption.

The entire disclosure[s] of all applications, patents and publications, cited herein and of corresponding German Application No. DE 10 201 0 010738.7, filed Mar. 9, 2010 are incorporated by reference herein.

The preceding examples can be repeated with similar success by substituting the generically or specifically described reactants and/or operating conditions of this invention for those used in the preceding examples.

1. A method for producing a glycerol-containing feedstock suitable for use as a feed to a pyrolysis process, said method (20) comprising:
subjecting (1, 2) a glycerol-containing feedstock mixture (G) to at least partial vaporization (1) by thin-film evaporation to obtain a vaporization product (V), suitable for use as a feed to a pyrolysis process.

2. A method according to claim 1, wherein said at least partial vaporization (1) of the feedstock mixture (G) is carried out at a temperature of above 200° C.

3. A method according to claim 2, wherein said at least partial vaporization (1) of the feedstock mixture (G) is carried out at a temperature of 200 to 240° C.

4. A method according to claim 2, wherein said at least partial vaporization (1) of the feedstock mixture (G) is carried out at a temperature of 200 to 220° C.

5. A method according to claim 1, wherein said at least partial vaporization (1) of the feedstock mixture (G) is carried out at an absolute pressure of 50 to 85 mbar.

6. A method according to claim 1, further comprising scrubbing said vaporization product (V) in a scrubber to produce a product suitable for use as a feed for a pyrolysis process.

7. A method according to claim 1, wherein said glycerol-containing feedstock mixture (G) is crude glycerol or substandard glycerol, preferably from biodiesel production.

8. A method according to claim 1, further comprising subjecting said feedstock mixture (G) to purification, drying and/or saponification, prior to said thin-film evaporation.

9. A method for generating a hydrogen-containing product mixture (H) from a glycerol-containing feed, comprising subjecting a vaporization product (V) or a product suitable for use as a feed for a pyrolysis process produced according to claim 1 to pyrolysis, obtaining a pyrolysis product (P), and reacting the pyrolysis product (P) to obtain said hydrogen-containing product mixture (H).

10. A method according to claim 9, wherein said pyrolysis product (P) is subjected to catalytic reaction to produce said hydrogen-containing product mixture (H).

11. A method according to claim 10, wherein said pyrolysis product (P) is reacted by steam reformation and/or partial oxidation to obtain said hydrogen-containing product mixture (H).

12. A method according to claim 1, further comprising setting the water content of the feedstock mixture (G) or said vaporization product (V), or said product suitable for use as a feed for a pyrolysis process.

13. A method according to claim 1, further comprising y setting the water content of the feedstock mixture (G), the vaporization product (V), the glycerol-containing feedstock suitable for use as a feed to a pyrolysis process, the pyrolysis product (P), and/or of the product mixture (H).

14. An apparatus comprising a thin-film evaporator, a scrubbing appliance, a pyrolysis reactor and a reactor for converting pyrolysis product to obtain a hydrogen-containing product mixture.

15. An apparatus comprising:
a thin-film evaporator having an inlet for introducing a glycerol-containing feedstock mixture, a cylindrical evaporator wherein the glycerol-containing feedstock mixture flows downwardly on an internal surface said cylindrical evaporator, and an outlet for discharging a vaporization product (V),
a scrubber for scrubbing said vaporization product (V), said scrubber having an inlet for receiving said vaporization product (V) from the outlet of said thin-film evaporator, and an outlet for discharging scrubbed vaporization product (V) from said scrubber,
a pyrolysis reactor for subjecting said scrubbed vaporization product (V) from said scrubber to pyrolysis, said pyrolysis reactor having an inlet for receiving scrubbed vaporization product (V) from said scrubber, means within said pyrolysis reactor for pyrolyzing said scrubbed vaporization product (V), and an outlet for discharging a pyrolysis product (P) from said pyrolysis reactor, and
and a reactor for subjecting the pyrolysis product (P) to steam reformation and/or partial oxidation to obtain a hydrogen-containing product mixture (H).

16. Method (20) for processing (1, 2) a glycerol-containing feedstock mixture (G) to give an intermediate (I), in particular in a method (10) for generating a hydrogen-containing product mixture (H) from the intermediate (I) by means of pyrolysis (3), obtaining a pyrolysis product (P) and with catalytic reaction (4) of the pyrolysis product (P), characterized in that the processing (1, 2) includes at least partial vaporization (1) of the feedstock mixture (G) by thin-film evaporation, obtaining a vaporization product (V).

17. Method (10) for generating a hydrogen-containing product mixture (H) from an intermediate (I) produced from a glycerol-containing feedstock mixture (G) by means of pyrolysis, obtaining a pyrolysis product (P) and reacting the pyrolysis product (P), characterized in that the production of the intermediate comprises a method (20) according to claim 16.

18. Device which is equipped for carrying out a method according to claim 17, having a thin-film evaporator, a scrubbing appliance, a pyrolysis appliance and a reaction appliance.
